(19) United States
(12) Patent Application Publication
(10) Pub. No.: US 2021/0331920 A1
(43) Pub. Date: Oct. 28, 2021

(54) METHOD FOR PRODUCING HYDROGEN FLUORIDE FROM AN AQUEOUS SOLUTION OF HEXAFLUOROSILICIC ACID

(71) Applicant: New Chemical Products LLC, St. Petersburg (RU)

(72) Inventors: Dmitrii Stanislavovich PASHKEVICH, Saint-Petersburg (RU); Dmitry Anatolievich MUKHORTOV, Saint-Petersburg (RU); Pavel Sergeevich KAMBUR, Murino (RU); Valentin Valerievich KAPUSTIN, Saint-Petersburg (RU)

(21) Appl. No.: 16/332,687

(22) PCT Filed: Mar. 1, 2018
(86) PCT No.: PCT/RU2018/000122

§ 371 Date: Mar. 12, 2019

(30) Foreign Application Priority Data
Jan. 16, 2018 (RU) 2018101617

(51) Int. Cl. C01B 7/19; C01B 33/12

(52) U.S. Cl. CPC C01B 7/193; C01B 33/126; C01B 7/197

(57) ABSTRACT

A technique for obtaining anhydrous hydrogen fluoride (AHF) from an aqueous solution of hexafluorosilicic acid (HSA). A method for obtaining hydrogen fluoride from an aqueous solution of hexafluorosilicic acid can include mixing a solution of hexafluorosilicic acid with a sulfuric acid solution, desorbing the hydrogen fluoride from the resultant solution of sulfuric acid, treating it with sulfuric acid and condensing the anhydrous hydrogen fluoride from unabsorbed gasses. The generated gaseous products are then burned in a fire of hydrogen-containing fuel and an oxygen-containing oxidant, yielding a solid silicon dioxide. The remaining products are cooled and yield condensed anhydrous hydrogen fluoride.

### CROSS-REFERENCE TO RELATED APPLICATIONS

This patent application is a section 371 nationalization of PCT Application No. PCT/RU2018/000122 filed Mar. 1, 2018, which claims priority to Russian Patent Application No. RU2018101617 filed Jan. 18, 2018 now Russian Patent No. 2669838 granted Oct. 16, 2018, which applications are each incorporated herein by specific reference in their entirety.

### BACKGROUND

### Field

This patent relates to a technique for inorganic substances, particularly a method for producing anhydrous hydrogen fluoride (AHF) from an aqueous solution of hexafluorosilicic acid (HSA).

### Description of Related Art

AHF has widespread industrial applications. It is used in various production processes of the chemical industry, for example, in the synthesis of fluorinated coolants, in the production of uranium hexafluoride and more. HSA typically forms as a byproduct in the production of phosphoric acid or phosphate-based fertilizers as an aqueous solution containing 10-20 wt % H₂SiF₆.

A known method of producing AHF by processing HSA [U.S. Pat. No. 4,062,930, IPC S01V 7/22, pub. 13 Dec. 1977] is to expose HSA to concentrated sulfuric acid at a temperature of 150-170° C.

This reaction takes place (1):

nH₂O+H₂SiF₆+mH₂SO₄→mH₂SO₄.nH₂O+2HF↑+SiF₄↑ (1)

Selective absorption with sulfuric acid is used to separate the resulting gaseous products. Hydrogen fluoride dissolves in sulfuric acid, forming fluorosulfuric acid in the reaction (2):

HF+H₂SO₄↔HSO₃F+H₂O. (2)

Reaction (2) is reversible, and its equilibrium is dependent on the solution's temperature and water content. Therefore, the sulfuric acid absorbs the hydrogen fluoride and separates it from the solution at a temperature above 150° C., after which it is condensed and collected in the collecting tank.

The silicon tetrafluoride remaining after absorption is sent to recycling, where it mixes with the initial HSA solution and interacts with the water in the solution according to the reaction equation (3):

3SiF₄+2H₂O→2H₂SiF₆+SiO₂. (3)

The silicon dioxide formed contains a fluoride-ion admixture, which is filtered out and disposed of as waste, while the HSA solution is processed with sulfuric acid. Disadvantages of this method are that, firstly, silicon dioxide forms as a waste product, and secondly, the gel suspension of silicon dioxide separated from the aqueous solution requires an energy-intensive filtration stage and uses water to rinse the filtrate, after which the rinse water is also channeled to sulfuric acid processing together with the initial HSA.

The closest technical solution is a method [Dahlke T., Ruffiner O., Cant R., Production of HF from H₂SiF₆, Procedia Engineering, 138, 231-239 (2016)], which is also derived from the previously described method, based on the principle of dissolving aqueous HSA in sulfuric acid, yielding hydrogen fluoride and silicon tetrafluoride. Silicon tetrafluoride, hydrogen fluoride and water are separated via selective absorption. The isolated silicon tetrafluoride is hydrolyzed with a dilute solution of HSA. However, the difference lies in that, when mixed with concentrated sulfuric acid and HSA, the gaseous reaction products primarily contain silicon tetrafluoride. The hydrogen fluoride is primarily absorbed by the sulfuric acid in the mixing reactor, which is then sent off for desorption. Extracting hydrogen fluoride from a solution containing sulfuric acid occurs in the desorber, where the solution is heated, causing the fluorosulfuric acid in it to dissolve. Then the contents are treated with water vapor and air in a stripping column for the most complete elimination of hydrogen fluoride admixtures from the sulfuric acid. The silicon tetrafluoride formed by reaction (1) is channeled to the hydrolysis reactor, where it mixes with the initial HSA solution and is hydrolyzed to form silicon dioxide.

The main disadvantage of this method is that it forms a gel-like suspension of silicon dioxide, which requires filtration. Filtration leads to an increase in energy consumption and rinse water. Therefore, several disadvantages emerge: the first in the increased energy consumption during the process, the second in the increased consumption of concentrated sulfuric acid, and third in the formation of silicon dioxide waste contaminated with fluoride ions.

### SUMMARY

The technical result achieved by implementing the proposed patent is the extraction of hydrogen fluoride from an aqueous solution of HSA, while reducing the energy and resource consumption during the process as well as the amount of waste formed.

### BRIEF DESCRIPTION OF THE FIGURES

FIG. 1 displays a diagram of the unit used to produce hydrogen fluoride from an aqueous HSA solution

### DETAILED DESCRIPTION

The core of the proposed solution lies in the method of obtaining hydrogen fluoride from an aqueous solution of hexafluorosilicic acid, which involves mixing a hexafluorosilicic acid solution with a solution of sulfuric acid, further desorbing hydrogen fluoride from the resulting sulfuric acid solution, treating it with sulfuric acid and condensing hydrogen fluoride from the unabsorbed gases. During this process, the hexafluorosilicic acid solution is mixed at a temperature of 100-190° C. with sulfuric acid at a concentration of at least 71 wt % in an amount no less than (0.7*(100−a))/(x−70) grams per 1 gram of hexafluorosilicic acid solution in the solution, where x is the % concentration of sulfuric acid and a is the % concentration of hexafluorosilicic acid solution. Then the resulting gaseous products are burned off in a fire of a hydrogen-containing fuel and an oxygen-containing oxidant, yielding a solid silicon dioxide. The remaining products are cooled with extraction of condensed anhydrous hydrogen fluoride.

A possible alternative to the primary technical solution is to pre-treat the gaseous reaction products with concentrated sulfuric acid at a concentration of at least 71 wt %, after which the unabsorbed gases are burned off and the waste sulfuric acid is returned to the mixing stage with the hexafluorosilicic acid solution.

In this manner, the essential features achieve the claimed technical result. Firstly, energy consumption of the process is reduced when burning the silicon tetrafluoride formed. Secondly, burning the silicon tetrafluoride leads to the absence of waste silicon dioxide contaminated with fluoride ions. Thirdly, sulfuric acid consumption is reduced by using the given ratio of HSA solution and sulfuric acid.

This ratio of the initial reagents (sulfuric acid and HSA solution), which was obtained experimentally after mixing and the decomposition of HSA, yielding hydrogen fluoride and silicon tetrafluoride, allows achieving a concentration of sulfuric acid of no less than 70 wt % after the interaction.

Decomposition in reactions (1) and (2) leads to yielding gaseous reaction products consisting of silicon tetrafluoride, hydrogen fluoride and water vapor. The given initial concentration of sulfuric acid ensures the decomposition of HSA and the yield of a minimal amount of water vapor into the gaseous phase. The reaction temperature should be no lower than 100° C., which ensures the HAS will decompose into silicon tetrafluoride and hydrogen fluoride but no higher than 190° C. to prevent sulfuric acid vapor and higher levels of water vapor from releasing with the gaseous products.

Treating the gaseous products with sulfuric acid before burning makes it possible to reduce the load at the combustion stage, as the gaseous products from the hydrogen fluoride and water reaction will have been absorbed previously. Reducing the load at the burning stage minimizes the amount of methane and oxygen fed to the process, which can further decrease resource consumption during the extraction of hydrogen fluoride from the aqueous HSA solution.

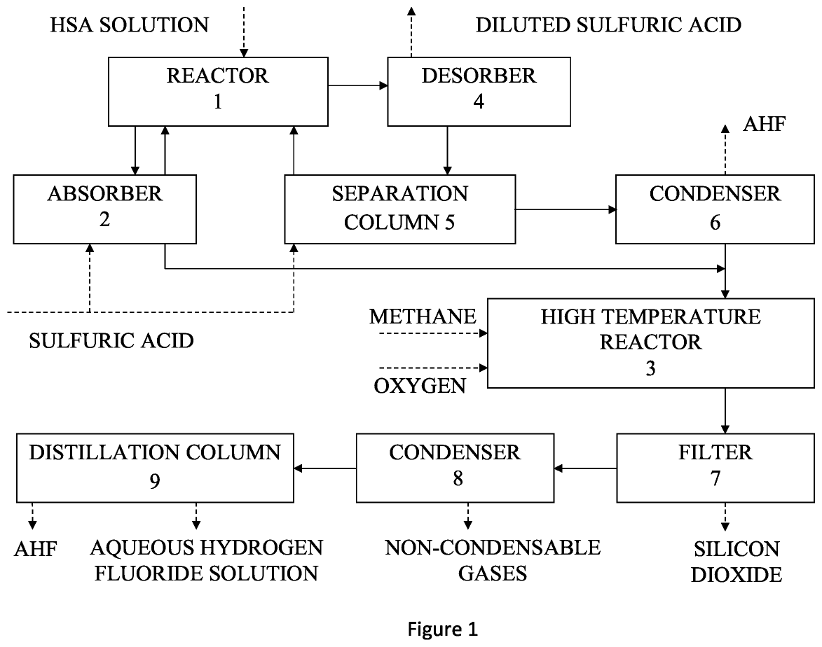

The FIG. 1 displays a diagram of the unit used to produce hydrogen fluoride from an aqueous HSA solution, where:
1—reactor
2—absorber
3—high-temperature reactor
4—desorber
5—separation column
6—condenser
7—filter
8—hydrogen fluoride condenser
9—distillation column

The method is performed as follows: The initial aqueous HSA solution mixes with sulfuric acid at a concentration of at least 71 wt % at a temperature of 100-190° C. in reactor 1. During this process, a ratio between sulfuric acid and HSA solution is selected, so that there is at least (0.7*(100−a))/(x−70) grams of sulfuric acid per one gram of HSA solution. As a result of decomposition in reactions (1) and (2) gaseous products are formed consisting of silicon tetrafluoride, hydrogen fluoride and water vapor. The gaseous reaction products are sent into absorber 2 for treatment with sulfuric acid at a concentration of at least 71 wt %. During the treatment with the sulfuric acid, water vapor and hydrogen fluoride are trapped from the gas stream, and the remaining stream of silicon tetrafluoride is channeled into the fire of the hydrogen-containing fuel and oxygen-containing oxidant of high-temperature reactor 3.

The sulfuric acid diluted with fluorosulfuric acid and hydrogen fluoride, remnants from mixing the sulfuric acid and HSA solution, is purified using known methods to remove the dissolved hydrogen fluoride from it, for example, by heating with the decomposing fluorosulfuric acid in reaction (2), and desorbing the hydrogen fluoride and a residual amount of silicon tetrafluoride in desorber 4. After desorption, we obtain a sulfuric acid with a fluorine content expressed as hydrogen fluoride of no more than 1 wt %. The gaseous products formed during desorption, which consist of hydrogen fluoride, water vapor and silicon tetrafluoride, are treated with concentrated sulfuric acid in separation column 5. Water vapor and partially hydrogen fluoride are trapped from the stream during this treatment. Afterwards the remaining gaseous stream, which contains hydrogen fluoride and silicon tetrafluoride, is cooled in condenser 6. Here, anhydrous hydrogen fluoride is condensed and sent on for further use. The silicon tetrafluoride is combined with the silicon tetrafluoride from the stage of sulfuric acid absorption of gaseous products from the aqueous HSA solution and channeled into high-temperature reactor 3 for combustion in the fire of hydrogen-containing fuel and oxygen-containing oxidant. Streams of waste sulfuric acid, formed after treatment of the gaseous streams, are fed to reactor 1 to mix with the initial HSA.

Combustion of the fuel and oxidant in high-temperature reactor 3 creates the temperature needed for reaction (4):

SiF₄+2H₂+O₂→SiO₂+4HF. (4)

Solid, finely-dispersed silicon dioxide is separated from the combustion products at filter 7, after which the dust-free combustion products cool in hydrogen fluoride condenser 8. The hydrogen fluoride and water condense and yield anhydrous hydrogen fluoride through distillation in distillation column 9, which is then combines with the anhydrous hydrogen fluoride from condenser 6.

This method provides a means of extracting anhydrous hydrogen fluoride from an aqueous solution of HSA, while achieving the claimed technical result. First, the energy consumption is lower without the use of the suspension filtering stage. Second, omitting the filtering stage results in the absence of waste silicon dioxide contaminated with fluoride ions. Third, the given ratio of sulfuric acid and the aqueous HSA solution reduces sulfuric acid consumption.

### METHOD EXAMPLES

### Example 1

The initial aqueous solution of HSA with a 15 wt % concentration was fed at a flowrate of 500 mg/s into reactor 1. Sulfuric acid from units 2 and 5 was also fed into reactor 1 as well as sulfuric acid with a 93 wt % concentration. The total overall consumption of sulfuric acid entering the reactor was 1295 mg/s, determined by the ratio of (0.7*(100−a))/(x−70) grams per 1 gram of hexafluorosilicic acid solution in the solution, where x is the % concentration of sulfuric acid and a is the % concentration of hexafluorosilicic acid. Inserting these into the formula yields: 0.7*(100-15)/(93-70)=2.59. Components in reactor 1 were mixed at 170° C. Gaseous products were directed to absorber 2 and irrigated with 93% sulfuric acid at a flowrate of 135 mg/s. Water and hydrogen fluoride vapor from the gaseous stream were trapped in absorber 2, while the remaining stream of silicon tetrafluoride was fed at a flowrate of 51 mg/s into high-temperature reactor 6, into which methane and oxygen were also supplied.

Diluted sulfuric acid with dissolved fluorosulfuric acid and hydrogen fluoride was extracted from reactor 1. This sulfuric acid was fed into desorber 4, where it was heated to 180° C., resulting in decomposition of the fluorosulfuric acid and desorption of the hydrogen fluoride and residual silicon tetrafluoride. The gaseous products produced in desorber 4, which contained hydrogen fluoride, water vapor and silicon tetrafluoride, were sent to separation column 5 at a flowrate of 74 mg/s and irrigated with 93% sulfuric acid at a flowrate of 65 mg/s. The resulting gaseous stream of hydrogen fluoride and silicon tetrafluoride, with a flowrate of 10 mg/s, was channeled into condenser 6, where it was cooled. The hydrogen fluoride was condensed, after which the uncondensed silicon tetrafluoride was combined with the silicon tetrafluoride from absorber 2 and sent to reactor 3 at a total flowrate of 54.2 mg/s for high-temperature processing in a fire of methane and oxygen. The dilute sulfuric acid with a 70 wt % concentration from desorber 4 contained no more than 1 wt % of hydrogen fluoride expressed as fluorine.

The combined stream of gases from condenser 6 and absorber 2 were fed into high-temperature reactor 3, which also received a feed of methane and oxygen at a flowrate of 8.3 mg/s and 33 mg/s, respectively. The combustion products from the reactor were transferred to filter 7, where solid, finely-dispersed silicon dioxide was separated at 26 mg/s. After the separation, the dust-free combustion products were transferred to hydrogen fluoride condenser 8, where the hydrogen fluoride and water were condensed, and anhydrous hydrogen fluoride was extracted from the resultant mixture via distillation in column 9. Remaining gases were sent off for sanitization.

### Example 2

Reactor 1 received a feed of the initial 25 wt % aqueous HSA solution at a flowrate of 100 mg/s, 90 wt % sulfuric acid at a flowrate of 227.5 mg/s, and the sulfuric acid solution from unit 5. The total flowrate of the sulfuric acid was 262.5 mg/s, which was determined by the ratio of (0.7*(100−a))/(x−70) grams per 1 gram of hexafluorosilicic acid solution in the solution, where x is the % concentration of sulfuric acid and a is the % concentration of hexafluorosilicic acid solution. Inserting these into the formula yields: 0.7*(100−25))/(90−70)=2.625. The components in reactor 1 were mixed at 115° C. Gaseous products were transferred to high-temperature reactor 3, as well as a feed of methane and oxygen.

Diluted sulfuric acid with dissolved fluorosulfuric acid and hydrogen fluoride was extracted from reactor 1. This sulfuric acid was fed into desorber 4, where it was heated to 180° C., resulting in decomposition of the fluorosulfuric acid and desorption of the hydrogen fluoride and residual silicon tetrafluoride. The gaseous products produced in desorber 4, which contained hydrogen fluoride, water vapor and silicon tetrafluoride, were sent to separation column 5 at a flowrate of 32 mg/s and irrigated with 90% sulfuric acid at a flowrate of 35 mg/s. The resulting gaseous stream of hydrogen fluoride and silicon tetrafluoride, with a flowrate of 6 mg/s, was channeled into condenser 6, where it was cooled. The hydrogen fluoride was condensed, after which the uncondensed silicon tetrafluoride was combined with the silicon tetrafluoride from reactor 1 and sent to reactor 3 for high-temperature processing at a total flowrate of 18 mg/s in a fire of methane and oxygen. The dilute sulfuric acid with a 70 wt % concentration from desorber 4 contained no more than 1 wt % of hydrogen fluoride expressed as fluorine.

The combined stream of gases from condenser 6 and reactor 1 entered high-temperature reactor 3, which also received a feed of methane and oxygen. The combustion products from the high-temperature reactor were transferred to filter 7, where solid, finely-dispersed silicon dioxide was separated at 26 mg/s. After the separation, the dust-free combustion products were transferred to hydrogen fluoride condenser 8, where the hydrogen fluoride and water were condensed, and anhydrous hydrogen fluoride was extracted from the resultant mixture via distillation in column 9. Remaining gases were sent off for sanitization.

As evident from the data, the issue facing the patent's authors has been resolved, namely that of creating a method of processing HSA to obtain AHF and making it possible to obtain a byproduct of finely-dispersed silicon dioxide, which is widely used in many industries (compound rubber production, suspension stabilization, etc.), while also avoiding the energy-intensive filtering operation of the silica gel formed.

The invention includes a technique for inorganic substances, namely, how to obtain anhydrous hydrogen fluoride (AHF) from an aqueous solution of hexafluorosilicic acid (HSA). This is a method for obtaining hydrogen fluoride from an aqueous solution of hexafluorosilicic acid that consists of mixing a solution of hexafluorosilicic acid with a sulfuric acid solution, desorbing the hydrogen fluoride from the resultant solution of sulfuric acid, treating it with sulfuric acid and condensing the anhydrous hydrogen fluoride from unabsorbed gasses. The hexafluorosilicic acid solution is mixed at a temperature of 100-190° C. with sulfuric acid at a concentration no less than 71 wt % in an amount no less than (0.7*(100−a))/(x−70) grams per 1 gram of hexafluorosilicic acid solution, where x is the % concentration of sulfuric acid and a is the % concentration of the hexafluorosilicic acid solution. The generated gaseous products are then burned in a fire of hydrogen-containing fuel and an oxygen-containing oxidant, yielding a solid silicon dioxide. The remaining products are cooled and yield condensed anhydrous hydrogen fluoride. Implementing the proposed patent achieved a technical result of extracting hydrogen fluoride from an aqueous solution HSA while reducing the energy and resource consumption of the process, as well as reducing the amount of waste generated.

1. A method for obtaining hydrogen fluoride from an aqueous solution of hexafluorosilicic acid, the method comprising:
mixing a solution of hexafluorosilicic acid with a sulfuric acid solution,
desorbing the hydrogen fluoride from the resultant solution of sulfuric acid, and treating it with sulfuric acid, and
condensing of anhydrous hydrogen fluoride from the non-condensable gasses.

2. The method of claim 1, wherein the hexafluorosilicic acid solution is mixed at a temperature of 100-190° C. with sulfuric acid at a concentration no less than 71 wt % in an amount no less than (0.7*(100−a))/(x−70) grams per 1 gram of hexafluorosilicic acid solution, where x is the % concentration of sulfuric acid and a is the % concentration of the hexafluorosilicic acid solution.

3. The method of claim 2, wherein the generated gaseous products are then burned in a fire of hydrogen-containing fuel and an oxygen-containing oxidant, yielding a solid silicon dioxide.

4. The method of claim 3, wherein the remaining products are cooled and yield condensed anhydrous hydrogen fluoride.

5. The method of claim 1, wherein the gaseous products of reaction are pre-treated with sulfuric acid with a concentration no less than 71 wt %, after which unabsorbed gases are combusted.

6. The method of claim 5, wherein waste sulfuric acid is returned to the stage of mixing with a solution of hexafluorosilicic acid.
